(19) United States
(12) Patent Application Publication
(10) Pub. No.: US 2014/0169002 A1
(43) Pub. Date: Jun. 19, 2014

(54) LAMP REFLECTOR

(71) Applicant: Jordan Reflektoren GmbH & Co. KG, Wuppertal (DE)

(72) Inventors: Andreas Möcking, Schwelm (DE); Ioannis Laftsidis, Wuppertal (DE); Kai Elfmann, Wuppertal (DE)

(73) Assignee: Jordan Reflektoren GmbH & Co. KG, Wuppertal (DE)

(21) Appl. No.: 14/107,345

(22) Filed: Dec. 16, 2013

Related U.S. Application Data
(60) Provisional application No. 61/811,862, filed on Apr. 15, 2013.

(30) Foreign Application Priority Data
Dec. 17, 2012 (DE) 20 2012 104 901.5

(51) Int. Cl. F21V 7/04

(52) U.S. Cl. CPC F21V 7/048
USPC 362/346

(57) ABSTRACT

A lamp reflector having a reflector body enclosing an inner space, whose peripheral wall forms a lateral surface of a geometrical body with a longitudinal axis. The reflector body has a light exit opening and a base section opposite thereto. The peripheral wall is formed by a wall section forming the base section, and, extending therefrom in the direction of the light exit opening, by circumferential adjacent segments that are separated by slots. The segments are secured to the perimeter of the reflector body via a holding ring that encloses it. On their free ends, the segments have outward angled flange sections that jointly form a circumferential flange rim. In its mounting position, the holding ring is adjacent to the flange rim and is at least force-fitted to the flange rim.

### CROSS REFERENCE TO RELATED APPLICATIONS

This application claims priority to U.S. Provisional Patent Application No. 61/811,862 entitled LAMP REFLECTOR, filed on Apr. 15, 2013, which claims priority to German Patent Application No. DE 20 2012 104 901.5, filed on Dec. 17, 2012, the entire contents of which are hereby incorporated by reference.

### BACKGROUND

1. Field of the Invention

The present invention relates to a lamp reflector having a reflector body enclosing an inner space, whose peripheral wall forms a lateral surface of a geometrical body with a longitudinal axis, the reflector body having a light exit opening, and a base section opposite the light exit opening, the peripheral wall being formed by a wall area that forms the base section, from where circumferentially adjacent segments separated by slots extend in the direction of the light exit opening.

2. Description of Related Art

A reflector of the type to which the present invention relates has been described as a “round reflector” in EP 2 325 549 A1. In this known round reflector, the holding ring is slid onto and attached to the outer circumference of the reflector with segments configured as star-shaped, strip-like fingers which are molded onto the reflector. For this attachment, it provided that the circular rung has two or more inward pointing catch projections on its inner rim border, which, in the target mounting position slid from the outside onto the reflector, engage with recesses configured on the reflector and secure the ring to the reflector in this way. The disadvantage here is that the reflector has recesses in the region of its reflective surface through which the catch projections of the ring are visible. In addition, the individual segments or “fingers” are only in part secured to the ring; depending on the number of joining points, numerous segments remain radially movable inward and prone to being deformed. The mounting is also difficult because the catch projections of the ring must be inserted as fitting accurately into the recesses of the reflector.

U.S. Pat. No. 4,855,884 also describes a segmented reflector, which consists of a continuous circumferential center part and a plurality of radial segments or wings, which likewise are supported and secured in a ring. In this case, the ring with inner projections also engages in the openings of some segments. As a support flange, the ring is part of a structural frame which holds the reflector and allows a certain regulation of the reflector curvature.

### SUMMARY

The underlying object of the present invention is to improve a lamp reflector of the kind mentioned above such that improved characteristics and an improved mechanical stability can be achieved with a simplified manufacturability.

According to the present invention, this object is attained based on the lamp reflector including a holding ring adjacent to a flange rim in its mounted position and that is at least joined to the flange rim in a force-fitting manner. This arrangement, according to the present invention, makes a very quick and easy mounting possible by merely inserting the holding ring on the flange rim and joining it thereto, so that centering and holding means for the holding ring can be omitted during the mounting, and also that additional recesses are not necessary on the reflector body in the region of the reflective surface to hold the securing means configured on the holding ring. According to the present invention, it is advantageous if the holding ring is joined to each flange section, so that each of the individual segments is joined to the holding ring and, in this respect, the entire reflector body is definitely secured in its position and the segment cannot be radially deformed. According to the present invention, it is convenient if the holding ring is attached to the rear side of the flange rim facing the base section, enclosing the segments at their outer circumference. This results in an especially simple mounting. Alternatively, it can likewise be an advantage if the holding ring is attached to the side of the flange rim facing away from the mounting section, that is, on the visible side. As a result of this, the slot sections in the flange rim situated between the segments are covered by the holding ring, as a result of which the optical appearance of the reflector is improved. It is likewise within the scope of the invention, if a holding ring is attached to the side of the flange rim facing the mounting section as well as to the side of the flange rim facing away from the mounting section.

According to the present invention, it is convenient, if the holding ring is joined to the flange rim via a welded joint. This can conveniently be a laser-welded joint. The welded joint, in particular the laser welded joint, is appropriately executed such that the welding is applied between the flange rim and the holding ring to a material boundary layer of the flange rim or of the holding rim adjacent to the holding rim or to the flange rim. This welded joint ensures that no deformation or damage is caused by the welding on the visible side of the flange rim or to the holding ring facing away from the base section, so that the optical appearance of the visible side of the flange rim or of the holding ring is not modified by the welding. Welding is, in particular, carried out from the rear side by means of a laser, that is, the side facing the base portion, such that the material of the holding ring is first penetrated, and the welding between the holding ring and the flange rim of the reflector body is then carried out without penetrating the thickness of the material of the flange rim of the reflector body as such, so that the visible side of the flange rim remains untouched. The welding procedure is controlled by the output, in particular, of the laser and the welding time.

It is, however, also within the scope of the invention, if the joint between the holding ring and the flange rim is adhered. In this case, the adhesion is conveniently carried out with a double-sided adhesive tape, which is arranged between the holding ring and the flange rim.

Alternatively, it can likewise be convenient, if the holding ring and the flange rim are joined by means of mechanical joining means via a clinch connection, for example, which, by way of example, is known as “Tox” clinching.

According to the present invention, it can further be convenient, if the holding ring has a width on its contact side, which is greater than/equal to the width of the flange rim. By arranging the holding ring on the visible side of the flange rim, the slots in the region of the flange are completely covered. By arranging the holding ring on the rear side of the flange rim, the holding ring can also have a smaller width than the flange rim.

According to the present invention, it is in particular advantageous if the base section and the light exit opening are coaxially arranged relative to the longitudinal axis and lie on a perpendicular plane relative to it, an opening for luminaries being conveniently configured on the base section through which the luminaries can be inserted. The light exit opening as well as the opening for luminaries is preferentially executed as a circular opening. In this case, it is also particularly advantageous, if the flange rim runs on a plane perpendicular to the longitudinal axis, and, in particular, has an inner and outer circular peripheral contour. In this case, it is likewise an advantage if the holding ring has an inner and outer circular peripheral contour. It is further convenient, if the reflector body is shaped rotationally symmetrical to the longitudinal axis, the peripheral wall having a paraboloid shape in the longitudinal section in a plane passing through the center axis from the base section to the light exit opening, so that the reflector body has the shape of a rotational paraboloid. The reflector body is conveniently formed from a one-piece, flat material blank having a thickness from greater than/equal to 0.2 mm to less than/equal to 1 mm, in particular 0.5 mm. In this case, the reflector body is preferentially made by stamping and mechanical forming. The holding ring is conveniently formed from a flat material blank having a thickness from greater than/equal to 0.2 mm and less than/equal to 1 mm, in particular 0.5 mm. Aluminum is preferentially used as a material for manufacturing the reflector body as well as for manufacturing the holding ring. It is likewise within the scope of the invention, if the holding ring is advantageously configured as a formed part made of plastic, the material thickness being from greater than/equal to 0.5 mm to less than/equal to 3 mm.

A mechanical rigidity of the flange rim is effectuated by the holding ring according to the present invention and its attachment position at the flange rim, and, in particular, by the attachment of the holding ring to each of the individual segments. In this way, the reinforced flange rim joined to the holding ring can also be used for securing the reflector body in a lamp support. For this purpose, suitable cutouts can be configured as securing means in the region of the flange rim, and the holding ring joined thereto. It is likewise within the scope of the invention, and it can be convenient, if the holding ring is formed by a one-piece flange-like border area of a housing-like reflector support holding the reflector. In such a case, the reflector body is inserted into the reflector support until its flange rim formed by the segment borders contacts the flange-like border area of the reflector support serving as a holding ring and is then joined to said reflector body. The material preferred for manufacturing a reflector body according to the present invention is aluminum with a highly reflective surface as a reflective surface. In this case highly reflective is understood to be a surface, which, in particular, has as a reflectance greater than/equal to 90%, in particular, 95% to 98%. This can, for example, be anodized aluminum strip material, which is coated by means of a PVD procedure to create the reflection layer. Such a material can have a highly glossy surface with a slightly diffuse reflection of less than 5%, or it can also be a reflective surface with a higher diffusion, by way of example, in the range between 12% and 94%. It can also be a surface exclusively having a diffuse reflection. It is also within the scope of the invention, and it can be of advantage, if the reflective surface of the reflector body is facetted, for example has facets, which have convex and/or concave curvatures.

### BRIEF DESCRIPTION OF THE DRAWINGS

The invention will be described in more detail by means of the exemplary embodiments shown in the drawings, which show:

FIG. 1 is a perspective view of the outer and rear side of a lamp reflector according to the present invention;

FIG. 2 is an additional perspective view of the of the lamp reflector according to FIG. 1, diagonal to the front side of the light exit opening, in an intermediate state during the mounting of the holding ring;

FIG. 3 is an axial top view of the side of the light exit opening in the direction of arrow III according to FIG. 1;

FIG. 4 is an axial top view of the rear side of the opening for lamps in the direction of the arrow IV according to FIG. 1;

FIG. 5 is a top view of a still flat sheet metal blank of the reflector body prior to forming;

FIG. 6 is a diametral longitudinal section of a lamp reflector according to the present invention in an alternative embodiment;

FIG. 7 is a diagonal perspective view from the bottom side of a further embodiment of a lamp reflector according to the present invention during the mounting process; and

FIGS. 8a and 8b are different embodiments of a holding ring according to the present invention, as shown in FIG. 2.

Same parts are always designated with the same reference numerals in the different figures.

### DETAILED DESCRIPTION

With respect to the following description, it is explicitly stated that the invention is not restricted to the exemplary embodiments, and thus not to all or several characteristics of the described combinations of characteristics; rather, any individual partial characteristic of the/of any exemplary embodiment can also be considered as having inventive importance, also independently of all other partial characteristics described in connection therewith, alone and also in combination with any characteristics of another exemplary embodiment, as well as independently of the combinations of characteristics and retroactive application of the claims.

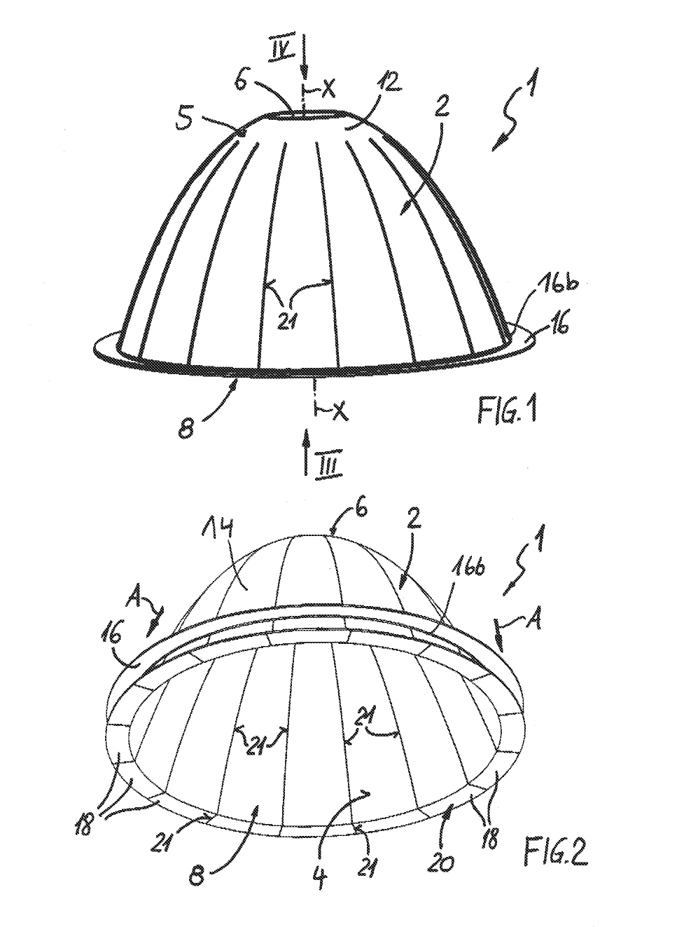

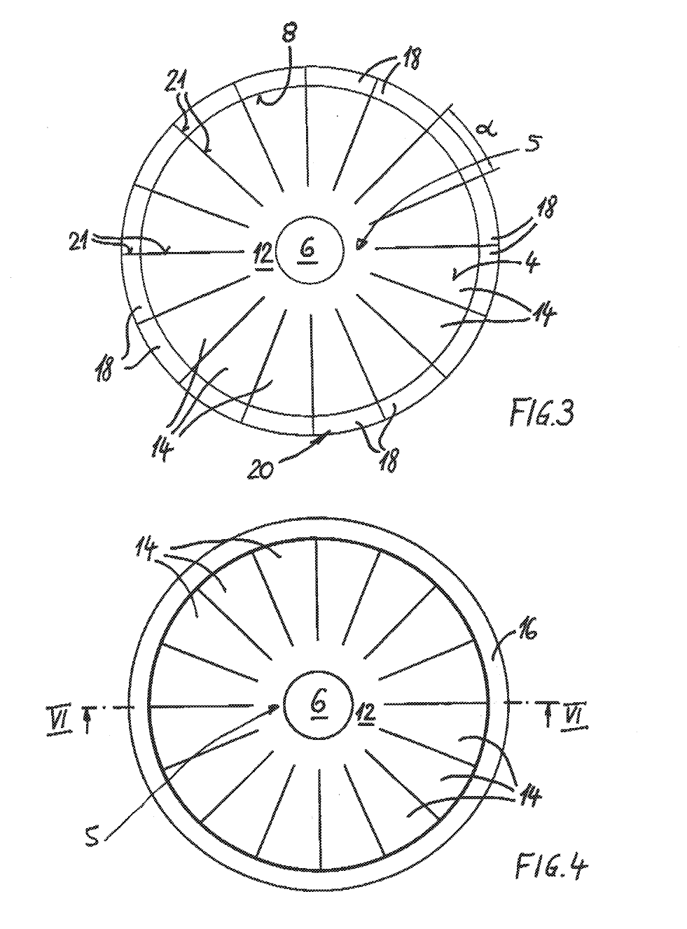

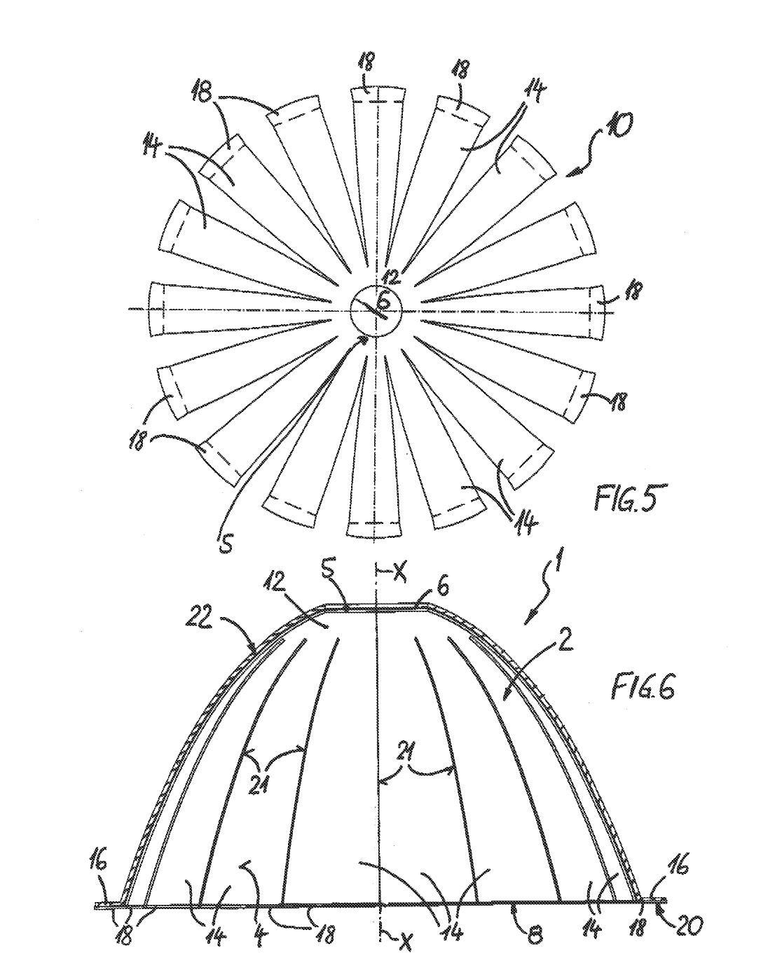

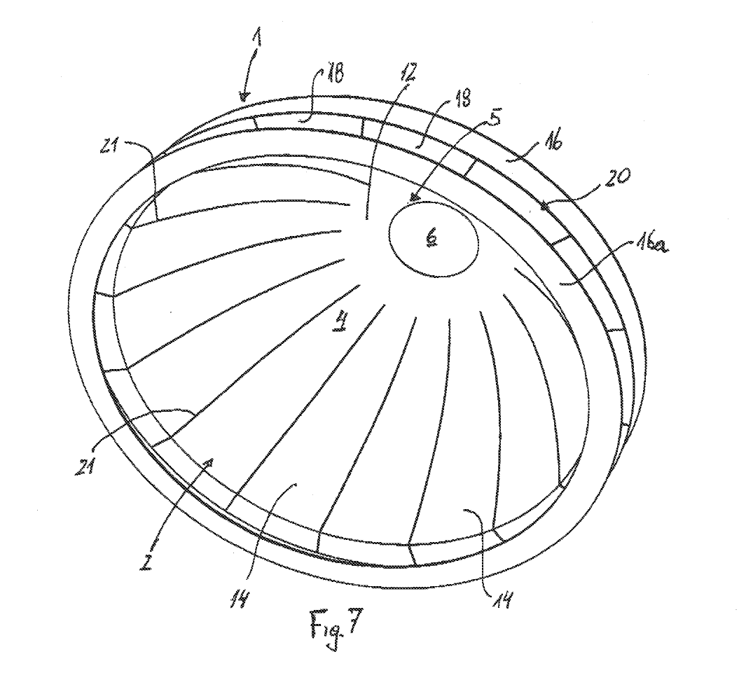

As is apparent from FIG. 1, a lamp reflector 1 according to the present invention consists of a reflector body 2, whose peripheral wall has a lateral surface of a geometrical body with a longitudinal axis X-X, the reflector body 2 having the shape of a rotational paraboloid in the shown exemplary embodiment. It can, however, likewise be an advantage if the reflector body 2 is configured in the shape of a truncated cone or of a pyramid, for example. The reflector body 2 has an inner reflective surface 4 (see also FIGS. 2, 3 and 6 in this respect). The reflector body 2 comprises an inner space, namely, a hollow inner space in the shown exemplary embodiment. The reflector body 2 has a light exit opening 8, and opposite this light exit opening 8 a base section 5 in its peripheral wall, in which a lamp opening 6 is configured in the shown advantageous exemplary embodiment. The light exit opening 8 and the lamp opening 6 are preferentially constructed as circular openings in the shown exemplary embodiment, the lamp opening 6 having a smaller diameter than the light exit opening 8. In this embodiment, a free inner cross-section of the reflector body 2, in particular, constantly increases from the base section 5 to the front light exit opening 8 toward the light exit opening 8 in the direction of its longitudinal axis X-X. The reflector body 2 is, in particular, formed by a one-piece material blank 10; see also FIG. 5 in this respect. The light exit opening 8 as well as the lamp opening 6 are advantageously arranged centered relative to the longitudinal axis X-X and extend in a vertical plane relative to the longitudinal axis X-X. The material blank 10 has a wall section 12, namely, in particular, a centric, disk-shaped wall area 12. Several strip-like adjacent segments 13 distributed over the periphery extend from the wall section 12 to the light exit opening 8. According to the shown advantageous paraboloid shape of the reflector body 2, the segments 14 enlarge with increasing distance from the wall area 12. Starting from the at first plane or flat shape of the material blank 10 according to FIG. 5, this blank 10 is mechanically formed by the segments 14 formed by stamping and separated by the slots 21, to form the reflector body 2 enclosing an inner space, e. g. hollow inner space. For this purpose, on the one hand, the segments 14 are curved radially, and, on the other hand, also in the circumferential direction such that, in their end position, they jointly have the desired body shape, in particular that of the shown rotational paraboloid. The segments 14 can, however, also run in a straight line in the circumferential direction, so that the cross-section of the reflector body 2 is not circular, but polygonal. In addition, the wall area 12 can correspondingly be configured as paraboloid-shaped, as shown in FIG. 1. It is, however, also possible to configure the wall area 12 as straight, perpendicular to the longitudinal axis X-X as a so-called “plateau”.

The segments 14 are secured in the region of their free ends via a holding ring 16. On their free ends, the segments 14 have outward angled, i.e. away from the inner space, in particular, perpendicular to the longitudinal axis X-X, flange sections 18, which, in the finished formed state of the reflector body 2, have a circumferential flange rim 20 enclosing the light exit opening 8 and lying in the plane of the light exit opening 8. In the finished mounting state, the segments 14 are situated with their lateral borders adjacent to one another without overlapping and separated by the slots 21. The same applies to the flange sections 18 forming the flange rim 20. The width of the slots 21 is, for example, 0.1 mm to 2 mm.

According to FIG. 3 each segment 14 extends in the circumferential direction with a circumferential angle α, which results from the total circumference of 360° divided by the number n of segments 14 results in: α=360°/n. In the shown exemplary embodiment, the reflector body 2, in particular, has n=16 segments 14, so that the angle α=360°/16=22.5°. Alternatively, any other number of segments 14 can also be selected.

According to the present invention, in its fitting mounting position, the holding ring 16, which encloses the reflector body 2 with its ring opening 16b, can at least be adhesively joined to the flange rim 20. In this case, it is advantageous, if the holding ring 16 is joined to each segment 14 at its flange section 18, so that the segments 14 can optimally be secured to one another. In the shown exemplary embodiment, the holding ring 16, in particular has an inner and an outer circular structure. The holding ring 16 is advantageously made of a plane sheet metal blank, in particular of aluminum, a material thickness from greater than/equal to 0.2 mm up to less than/equal to 1 mm, in particular of 0.5 mm, being advantageous. It is likewise within the scope of the invention, if the holding ring 16 is advantageously configured as a formed plastic part, a material thickness from greater than/equal to 0.5 mm to less than/equal to 3 mm being advantageous. In its ring opening 16b, the holding ring 16 has a shape that is adapted to the reflector body 2. Its outer circumferential contour can have any desired shape.

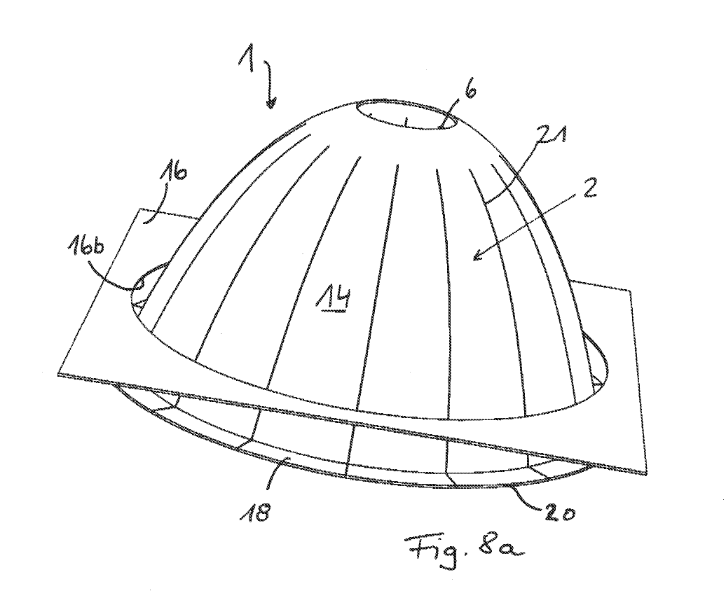

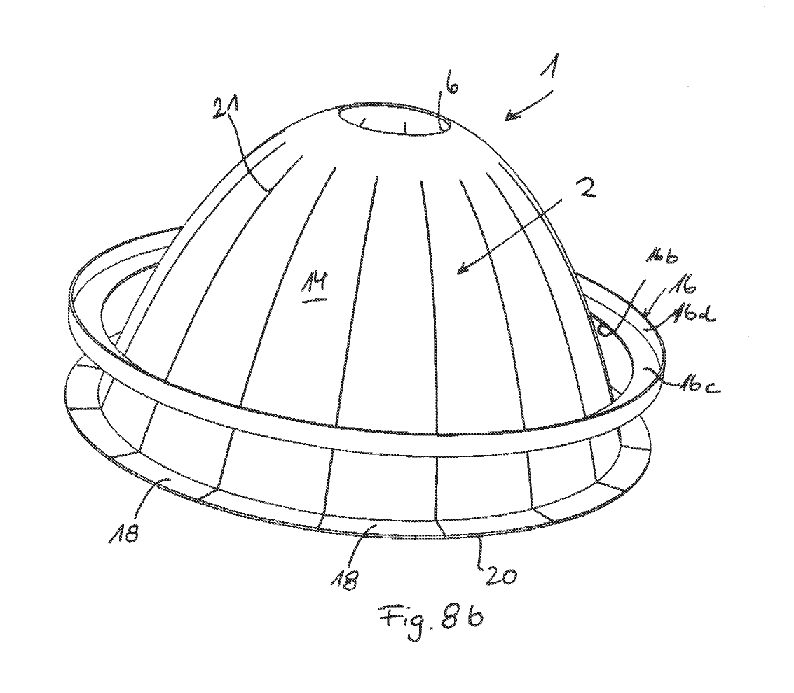

Thus, FIG. 8a shows that the holding 16 is configured as a plane plate-shaped blank in which the ring opening 16b has been cut out. The blank sections enclosing the ring opening 16b can be used to secure the lamp reflector 1. It is also within the scope of the invention, if several ring openings 16b are available to support reflector bodies 2 in the plate-shaped material blank. At the same time, FIG. 8b shows a holding ring 16, which consists of a ring section 16c adjacent to the flange rim 20 that encloses the ring opening 16b, and of a circumferential wall section 16d molded in particular at a 90° angle, onto the external border of the ring section 16c. The height of the circumferential wall section 16d is basically not restricted in this case. The wall section 16d can be used to attach the lamp reflector 1. It can likewise be provided according to the present invention that the sections 16c and 16d are part of the holding ring 16a, as shown in FIG. 7. The circumferential wall section 16d can be interrupted by recesses.

As shown in FIG. 5, prior to being mechanically formed, the reflector body 2 consists of a material blank made of a plane, i.e. flat material, in particular of metal. Aluminum is preferably used here, and the thickness of the used aluminum material is, in particular, greater than/equal to 0.2 mm to less than/equal to 1 mm, where, in particular, a material thickness of 0.5 mm can be used. The basic shape of the material blank shown in FIG. 5 can be executed as a stamped, bent part. The slots 21 can also be produced by means of a laser, which is also possible for the entire blank.

The inventive joint between the holding ring 16 and the flange rim 20 or between the individual flange sections 18 can accordingly be executed in different manners according to the present invention. In the embodiment shown in FIG. 6, it is inserted in the direction of the rear side of the flange rim 20 pointing in the direction of the base section 5. Alternatively, it can likewise be possible to attach a holding ring 16a to the front of the visible side of the flange 20 facing away from the base section 5. This is shown in FIG. 7, namely in the mounting state prior to the final attachment to the flange rim 20. At the same time, FIG. 7 shows that, according to the present invention, it is likewise possible to arrange a further holding ring 16 on the rear side of the flange rim 20, so that in this exemplary embodiment there is a bilateral attachment of a holding ring 16, 16a.

According to the present invention, it is now advantageously provided that the joint between the holding ring 16 or 16a and the flange rim 20 or between the holding ring 16 or 16a and the individual flange sections 18 is executed as a welded joint. In this case, it advantageously is a laser welded joint. The welded joint, in particular, the laser welded joint, is configured such that the welding between the holding ring 16 and the flange rim 20, or between the individual flange sections 16, is executed through the holding ring 16 in a material boundary layer of the flange rim 20 or of the flange sections 18 adjacent to the holding ring 16. With this configuration of the welded joint, no impairment of the surface on the front side, i.e. the visible side of the flange rim 20, is seen as a result of the welded joint. Insofar as the holding ring 16 is attached to the front side, i.e. on the visible side of the flange rim 20, as is shown in FIG. 7, the welded joint or the welding between the holding ring 16 and the flange rim 20 or the flange sections 18 is configured such that there is only one welding joint in the boundary layer of the holding ring 16a adjacent to the flange rim 20 or to the flange sections 18. The advantageous welding according to the present invention in the respective boundary layer can be accomplished by correspondingly adjusting the welding energy and welding time. The welding according to the present invention is advantageously executed as spot welding. Several, e. g. two welding spots per flange section 18 can also be provided. A linear welding joint can also be executed between the holding ring 16, 16a and the flange sections 18.

It is, however, also within the scope of the invention, and it can be an advantage, to accomplish the joint by means of an adhesive layer instead of the welded joint, for example. In this case, it is especially advantageous if the adhesive layer is a double-sided adhesive film. According to the present invention, it is likewise convenient if a mechanical joint, in particular, a so-called clinch joint, is provided between the flange rim 20 and the holding ring 20.

In the embodiment in which the holding ring 16 is arranged on the rear side of the flange rim 20 pointing in the direction of the base section 5 or of the lamp opening 6, as is shown in FIG. 2, the holding ring 16 is inserted outside, relative to the side of the base section 5 or of the lamp opening 6, on the reflector body 2 until it contacts the flange rim 20 and is then joined to the flange rim 20, e. g. by welding. Thus, on insertion, the holding ring secures the initially separated outer ends of the segments 14 with its inner edge region, and so automatically guides them to their target position in which, together with the flange sections 18 they form the, in particular, circular ring-shaped flange rim 20. This is apparent from the drawing in FIG. 2, the inserting direction of the holding ring 16 being indicated by arrows in FIG. 2. Advantageously, the holding ring 16 or 16a has a width which is greater than/equal to the width of the flange rim 20 in the region on the contact side of the flange rim 20.

In the embodiment shown in FIG. 6, the holding ring 16 is formed by a one-piece flange-shaped border of a housing-like reflector support 22 housing the reflector body 2. In this case, for the shown rotational paraboloid-shaped arrangement, the reflector support 22 thus correspondingly has a preferred rotational paraboloid-shaped inner contour adapted to the reflector body 2. The reflector support 1 can be formed in one piece and rotationally symmetrical from an originally flat round material blank, in particular from an aluminum sheet. This is usually executed by means of a so-called press method, the round sheet metal blank being pressed on a rotating patrix. The additional reflector support 22 leads to some advantages. The outer surface of the reflector support 22 can thus be configured almost at will to achieve an attractive design. Its outer surface can, for example, be enameled, sandblasted and/or metallically coated. In this respect, the reflector support 22 forms a lamp housing or reflector housing with any desired outer design. Besides, the reflector support 22 prevents light from being transmitted outside through the slots 21. Furthermore, the reflector support 22 can also be used as a means of connection to a lamp support and/or to a lamp.

On the side facing its inner space the reflector body 2 preferably consists of a light reflecting coated sheet metal, in particular of an aluminum sheet material coated by means of a PVD method. Here, an adhesive coating is applied to an aluminum carrier and an, in particular, ultra-pure silver coating is applied thereon. A reflection intensifying oxide coating system is applied to this ultra-pure silver layer. Such a material, in particular, has a reflectance of 95% to 98%. In this connection, a material with a high-gloss surface with low diffuse reflection below 5% is conveniently used. A material can, however, also be used which has a higher diffusion, for example, of 12% to 94%. On its side facing the inner space, the surface of the reflector body 2 can also be facetted, where convex and/or concave curvatures can be provided for the facets, which can be spatially configured in an even or uneven distribution on the surface of the reflector.

The invention is not restricted to the shown and described exemplary embodiments, but also comprises all embodiments having a similar effect consistent with the invention. It is expressly pointed out that the exemplary embodiments have not been restricted to the combination of all characteristics, and thus not to all or several characteristics of described combinations of characteristics, but rather each individual partial characteristic can also be fundamental to the present invention independently of all other partial characteristics. Furthermore, the invention has as yet not even been restricted to the combination of characteristics defined in the respective independent claims, but can also be defined by any other combination of specific characteristics of all disclosed individual characteristics. This means that basically each individual characteristic of the respective independent claims may in a manner of speaking be omitted and/or replaced by at least one individual characteristic disclosed at another point in the application. To this extent, the claims are to be understood merely as a first attempt at formulating the invention.

I/we claim:

1. A lamp reflector comprising a reflector body enclosing an inner space, whose peripheral wall forms a lateral surface of a geometrical body with a longitudinal axis (X-X), the reflector body having a light exit opening, and a base section opposite the light exit opening, the peripheral wall being formed by a wall section that forms the base section, from where circumferentially adjacent segments separated by slots extend in the direction of the light exit opening, the segments being secured via a holding ring that is adjacent thereto, the segments having outward angled flange sections extending away from the inner space on their free ends, which jointly form a circumferential flange rim, wherein in its mounting position the holding ring is adjacent to the flange rim and is at least force-fitted to the flange rim.

2. The lamp reflector according to claim 1, wherein the holding ring is joined to the flange rim by means of each flange section.

3. The lamp reflector according to claim 1, wherein the holding ring is attached to the flange rim on one of a rear side facing the base section or a visible side facing away from the base section.

4. The lamp reflector according to claim 1, wherein the holding ring is attached to the flange rim on a rear side facing the base section, and a further holding ring is attached to a visible side of the flange ring facing away from the base section.

5. The lamp reflector according to claim 1, wherein a welded joint is provided between the holding ring and the flange rim.

6. The lamp reflector according to claim 5, wherein the welded joint is a laser welded joint.

7. The lamp reflector according to claim 5, wherein the welded joint is configured such that the welding between the holding ring and the flange rim is applied in a material boundary layer of the flange rim or of the holding ring.

8. The lamp reflector according to claim 1, wherein the holding ring is joined to the flange rim via an adhesive joint.

9. The lamp reflector according to claim 8, wherein the adhesive joint consists of a double-sided adhesive film.

10. The lamp reflector according to claim 1, wherein the holding ring is joined to the flange rim via mechanical joint.

11. The lamp reflector according to claim 1, wherein the holding ring has a width which is greater than/equal to the width of the flange rim in the region of a contact side of the flange rim.

12. The lamp reflector according to claim 1, wherein the base section and the light exit opening are arranged concentrically to the longitudinal axis (X-X) and are situated in a perpendicular plane thereto.

13. The lamp reflector according to claim 1, wherein the base section has a circular lamp opening formed therein.

14. The lamp reflector according to claim 1, wherein the light exit opening has a circular shape.

15. The lamp reflector according to claim 1, wherein the flange rim extends perpendicularly to the longitudinal axis (X-X) and has an inner and outer peripheral contour.

16. The lamp reflector according to claim 1, wherein the holding ring has an inner and an outer circular peripheral contour.

17. The lamp reflector according to claim 1, wherein the reflector body is rotationally symmetrical to the longitudinal axis (X-X).

18. The lamp reflector according to claim 17, wherein the reflector body is configured as a rotational paraboloid.

19. The lamp reflector according to claim 1, wherein the reflector body is formed from a one-piece, plane material blank made of sheet metal, in particular, from an aluminum sheet and has a material thickness from greater than/equal to 0.2 mm to less than/equal to 3 mm, in particular of 0.5 mm.

20. The lamp reflector according to claim 19, wherein the reflector body is constructed by blanking or laser-cutting and mechanical forming.

21. The lamp reflector according to claim 1, wherein the holding ring formed from a plane material blank made of sheet metal or plastic and has a material thickness from greater than/equal to 0.2 mm to less than/equal to 1 mm using sheet metal, and from greater than/equal to 0.5 mm to less than/equal to 3 mm using plastic.

22. The lamp reflector according to claim 1, wherein the holding ring is formed by a flange area of a reflector support within which reflector body is located.

23. The lamp reflector according to claim 22, wherein the reflector support has an inner contour corresponding to the reflector body and which encloses the reflector body.

24. The lamp reflector according to claim 22, wherein the reflector support is formed in one piece and is rotationally symmetrical, the reflector support being formed from an originally flat, plane, circular blank made of metal.

25. The lamp reflector according claim 1, wherein the reflector body has a coating on a reflective surface facing the inner space, the reflective surface having a reflectance of 90% to 98%.

26. The lamp reflector according to claim 1, wherein the reflector body has a reflective surface facing the inner space, the reflective surface having a surface contour of one of concave and convex facets provided in one of an even or uneven spatial distribution.

27. The lamp reflector according to claim 1, wherein the holding ring is forms a securing mechanism for a reflector support.
